(19) United States
(12) Patent Application Publication
(10) Pub. No.: US 2006/0023999 A1
(43) Pub. Date: Feb. 2, 2006

(54) Manufacturing of optical devices including bragg gratings

(75) Inventor: Guido Chiaretti, Novate Milanese (MI) (IT)

Correspondence Address: GRAYBEAL JACKSON HALEY LLP;Suite 350, 155-108th Avenue N.E., Bellevue, WA, 98004-5973, US

(73) Assignee: STMicroelectronics S.r.I.

(21) Appl. No.: 11/172,384

(22) Filed: Jun. 29, 2005

(30) Foreign Application Priority Data
Jun. 29, 2004 (EP) EP04103032.1

(51) Int. Cl. G02B 6/34

(52) U.S. Cl. 385/37; 385/10

(57) ABSTRACT

A method of producing an optical device including a Bragg grating formed in an optical waveguide, the method comprising: providing a support substrate; positioning the optical waveguide with respect to an optical source so as to achieve a desired optical coupling of optical power emitted by the optical source into the optical waveguide; attaching the waveguide to the support substrate in correspondence of a first location along the waveguide, said first location being at one side of the Bragg grating; attaching the waveguide to the support substrate in a correspondence of a second location along the waveguide, said second location being at an opposite side of the Bragg grating, so as to freeze a first stress condition in the Bragg grating.

### PRIORITY CLAIM

1 This application claims priority from European patent application No. EP04103032.1, filed Jun. 29, 2004, which is incorporated herein by reference.

### TECHNICAL FIELD

The present invention relates generally to the field of optics and to optical devices, more specifically to optical communications and, in particular, to the manufacturing of optical devices used in optical communications. Even more particularly, the present invention concerns aspects related to the manufacturing, including packaging, of optical devices that include Bragg gratings.

### BACKGROUND

In the field of optics, optical devices are known that include Bragg gratings, particularly optical fiber Bragg gratings.

One such device is the so-called external cavity laser, also referred to as fiber grating laser or Hybrid Distributed Bragg Reflector (shortly, HDBR) laser.

As known in the art, a HDBR laser is formed by an active element (the optical source) and a reflector. The active element may comprise a semiconductor chip in which a Fabry-Perot semiconductor laser diode, or a Semiconductor Optical Amplifier (SOA), is integrated. The laser diode or, respectively, the SOA, has a first facet coated with a layer of reflective material, and a second, opposed facet coated with a layer of anti-reflection material. The reflector comprises a Bragg grating, formed in an optical fiber that is coupled to the active element, the second facet of which faces a tip or termination of the optical fiber.

In the PCT application WO 01/91259 (which is incorporated by reference) a HDBR laser adapted to the use in the field of optical communications, particularly in applications requiring very high transmission capacity (expressed as the transmission distance by the bit rate by the number of optical channels) has been described.

In order to be adapted to the use in such applications, a laser should be capable of being modulated at very high frequency (of the order of some GHz); additionally, it should have a very narrow optical emission spectrum; moreover, the emission wavelength should be very precise and stable in time, compared to the ITU grid.

The aspects inherent to the high-frequency modulation of the HDBR laser are described in the already cited WO 01/91259; without entering into excessive details, in that document it is described how to design the Bragg grating in order to ensure that the laser oscillates on a prescribed mode, even under condition of high-frequency direct modulation.

The narrowness of the optical emission spectrum is an inherent characteristic of HDBR lasers: it is in fact known in literature that this type of lasers have a rather pure continuous wave spectrum.

Emission wavelength precision and stability over time are two additional important requirements to be satisfied, so as to respect the standardized wavelengths specified in the ITU grid, and not to invade, during time, regions of the spectrum adjacent to that associated with the occupied optical communication channel; stability of the emission wavelength is in particular required to reduce, as far as possible, the cross-talk on adjacent channels.

The emission wavelength of an HDBR laser depends on the reflection wavelength of the Bragg grating; as known, the Bragg grating is substantially equivalent to a mirror reflecting optical radiation of a particular wavelength. The commercially available Bragg gratings, e.g. fiber Bragg gratings, exhibit a relatively large tolerance in respect of the grating reflection wavelength, due to production process yield considerations. Thus, unless specific measures are adopted, the resulting emission wavelength of an HDBR laser is rather imprecise.

In order to correct deviations of the laser emission wavelength from the target one, post-manufacturing calibration is often necessary during the packaging phase. In particular, the laser emission wavelength can be adjusted by applying a controlled stress to the fiber containing the grating.

Stability of the emission wavelength over time depends on the fact that the controlled stress applied to the fiber during the calibration is kept constant in time. In addition to this, it is to be considered that the grating reflection wavelength is also affected by variations in the operating environment temperature. Under this respect, it has been observed that even in cases where a thermal regulation element such as a Peltier cell is provided in the packaged optical device for thermally stabilizing the laser, the Bragg grating is usually positioned relatively far away from such thermal regulation element, being instead rather close to the package cover; heat originated outside the laser device can thus flow into the laser package and affect the frequency response of the Bragg grating; in particular, it has been observed that there is a linear relationship between the grating reflection wavelength variation and the Bragg grating temperature, with proportionality factor ranging from 0.0089 nm/C to 0.023 nm/C, depending on the specific packaging conditions.

### SUMMARY

In the light of the state of the art outlined in the foregoing, one of the problems that has been faced is how to ensure precision and stability of the spectral characteristics of a Bragg grating of the type used for example in HDBR lasers, particularly for high-capacity optical communications applications.

In particular, engineers have faced the problem of how to ensure that the optical radiation emitted by an HDBR laser is precise and stable over time, irrespective of changes in the operating conditions.

According to an aspect of the present invention, there is provided a method of producing an optical device including a Bragg grating formed in an optical waveguide. The method comprises:

providing a support substrate;

positioning the optical waveguide on the substrate with respect to an optical source so as to achieve a desired optical coupling of optical power emitted by the optical source into the optical waveguide;

attaching the waveguide to the support substrate in correspondence to a first location along the waveguide, said first location being at one side of the Bragg grating;

attaching the waveguide to the support substrate in a correspondence of a second location along the waveguide, said second location being at an opposite side of the Bragg grating, so as to block the Bragg grating in a first stressed condition, so that the first stress condition is “frozen” in the Bragg grating.

For the purposes of this discussion, by “stressed condition” it is intended any possible condition of stress applied to the Bragg grating, including a zero- or substantially zero-stress condition.

Other aspects of the present invention concern an optical device, a method of tuning an optical device and a tunable optical device.

### BRIEF DESCRIPTION OF THE DRAWINGS

Features and advantages of the present invention will be made apparent by the following detailed description of some embodiments thereof, provided merely by way of non-limitative examples, description that will be conducted making reference to the annexed drawings.

FIGS. 1A to 1F are schematic views of some of the relevant steps of a manufacturing method according to a first embodiment of the present invention, applied to the production and packaging of an HDBR laser.

FIG. 2 shows, in axonometric view, one of the steps of the manufacturing method of FIG. 1 according to an embodiment of the invention.

FIGS. 3A to 3F are schematic views of some of the relevant steps of a manufacturing method according to a second embodiment of the present invention, applied again to the production and packaging of an HDBR laser.

FIG. 4 is a schematic view of a manufacturing method according to a third embodiment of the present invention, applied to the production and packaging of a different type of optical device including a Bragg grating, particularly a wavelength-selective optical filter.

FIG. 5 is a schematic diagram of an optical subsystem in which the optical device of FIG. 4 can be used according to an embodiment of the invention.

### DETAILED DESCRIPTION

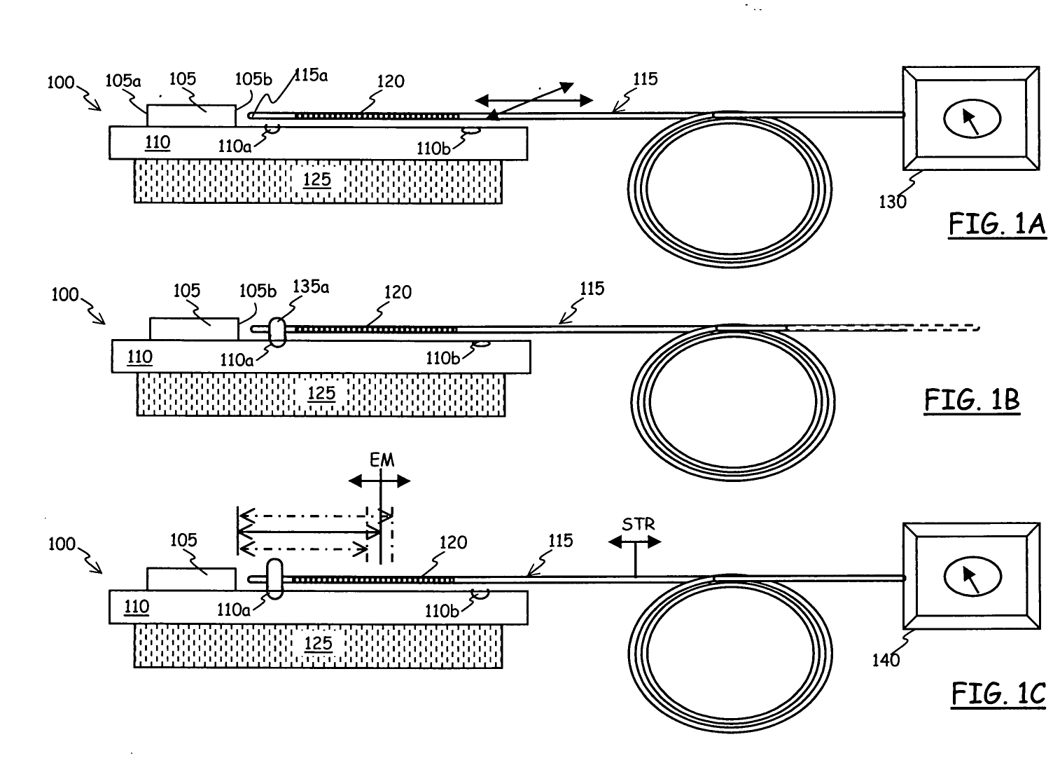

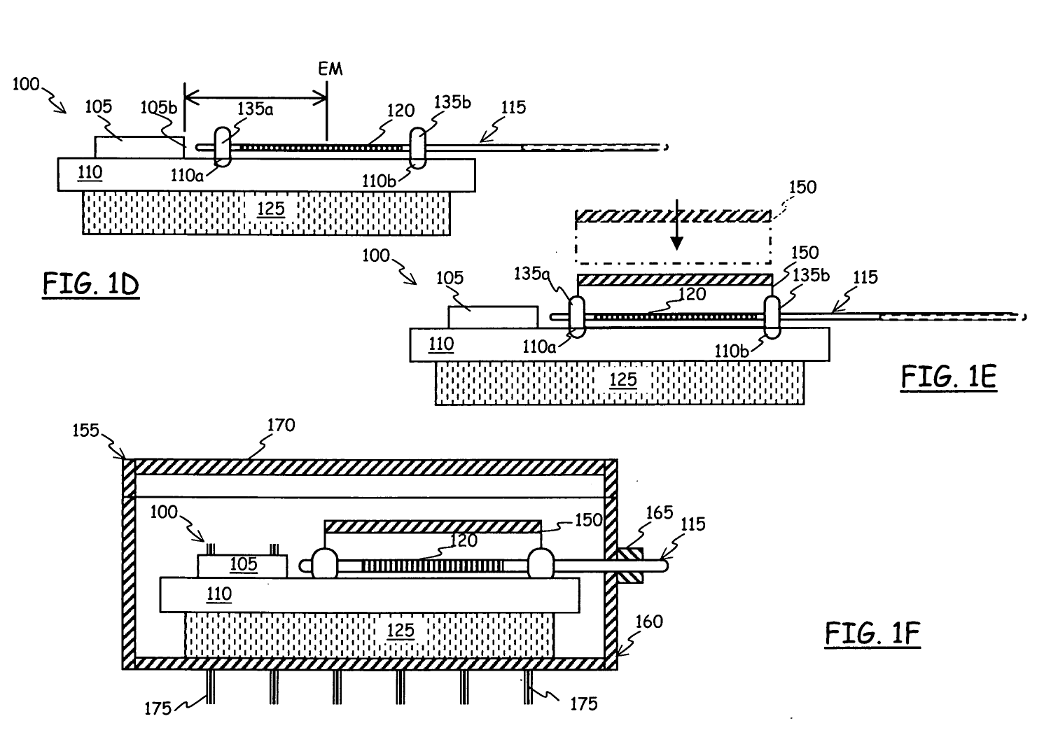

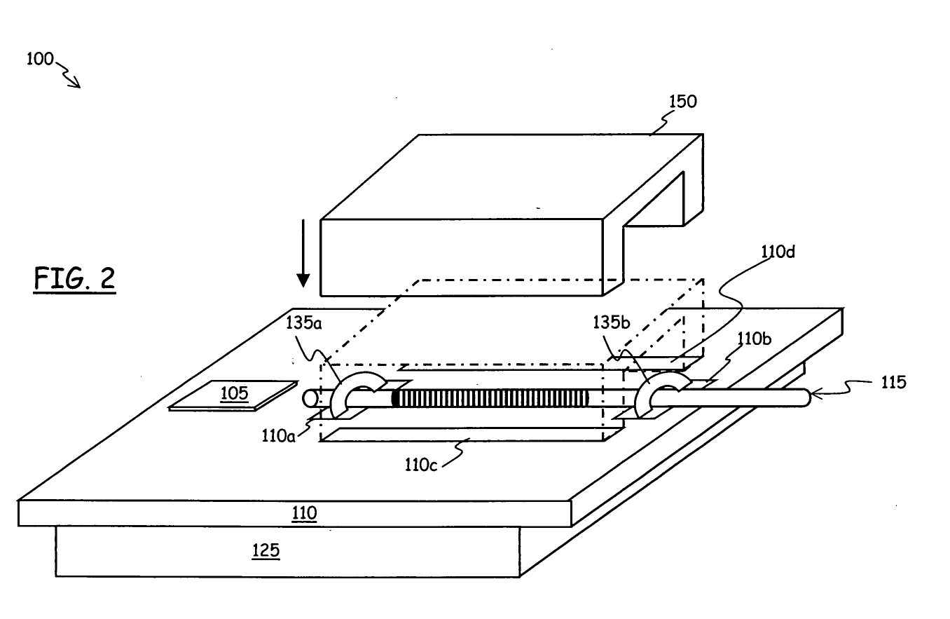

In FIGS. 1A to 1F and 2 there are schematically shown some of the relevant steps of a manufacturing method according to a first embodiment of the present invention, for the production, up to the packaging, of an optical device including a Bragg grating. In particular, the first embodiment of the invention described relates to the packaging of an HDBR laser.

Making reference to the drawings, an Optical Sub-Assembly (OSA) 100 includes a semiconductor material chip 105 wherein an optical active element, such as a laser diode, is integrated, attached (typically, bonded), in correspondence of a respective seat, to an OSA support substrate 110, in a material having sufficiently high thermal conductivity properties, for example of silicon or other semiconductors, SiC, diamond, SiGe, GaAs, InP, copper alloys, metals with low thermal expansion properties.

The optical active element 105, e.g. the laser diode, comprises for example a PN homojunction, such as of GaAs or InP, or alternatively an heterojunction, such as InP/InGaAsP. By way of example, a GaAs laser can be used in applications that provide for exploiting the first attenuation window of optical fibers, corresponding to wavelengths in the range 0.8 to 0.9 μm; a InP/InGaAsP laser can instead operate in the second and third optical fiber attenuation windows, corresponding to wavelengths of about 1.3 to 1.55 μm. However, the invention is not thus limited, applying as well to emitting sources operating at a shorter wavelength (UV or visible spectrum) or at longer one (near or far IR).

The optical active element 105 has a first and a second opposite facets 105a, 105b (corresponding to the facets of the chip 105); the first facet 105a is an optically reflecting facet (the chip facet is coated by a film of reflecting material), whereas the second facet 105b is only partially reflecting (the chip facet is coated by a film of low-reflectivity or anti-reflecting material) and forms an output port for the optical radiation.

The optical active element 105 is further provided with electrical terminals (not shown in the drawings for the sake of clarity) for applying a bias and modulation current I for the laser diode.

In order to form a HDBR laser, the laser diode 105 is coupled to an external optical waveguide, particularly an optical fiber 115 in a section of which a Bragg grating 120 is formed. In particular, the second, partially-reflecting facet 105b of the optical active element 105 is in optical coupling relationship with an input termination 115a of the fiber 115, proximate to which the Bragg grating 120 is located.

Techniques for forming Bragg gratings in optical waveguides, particularly optical fibers are known in the art, and are not limitative to the present invention.

In one embodiment, the Bragg grating 120 is realized according to the teachings provided in the already cited WO 01/91259, which is incorporated by reference; in such a way, a HDBR laser capable of being directly modulated at high frequency can be obtained. However, it is intended that the Bragg grating might as well be realized in different ways, not being per-se a limitation for the present invention.

Preferably, the input termination 115a of the fiber 115 is treated so as to form a lens, which allows enhancing the optical coupling to the facet 105b of the optical active element 105.

The OSA support substrate 110 is mounted to a thermal regulation element, e.g. a peltier cell 125, for stabilizing the temperature of the OSA, particularly of the optical active element 105 and the Bragg grating 120, with the purpose of reducing or eliminating thermal drifts of these two elements of the OSA.

According to the first embodiment of the invention being described, the optical active element 105 is first attached (bonded) to the OSA support substrate 110. Then, the fiber 115 is positioned on the OSA support substrate 110, having care to ensure proper alignment, and the distance of the fiber input termination 115a with respect to the radiation-emitting, second facet 105b of the element 105, so as to ensure good optical coupling. To this purpose, as depicted in FIG. 1A, the optical power coupled into the fiber 115 may be measured, by a suitable instrument 130, for example an optical power meter connected to an output termination of the fiber 115. While the fiber 115 is moved on the OSA substrate 110 with respect to the optical active element 105, the optical power emitted by the latter and coupled into the fiber is monitored by the optical power meter 130; the correct positioning of the fiber 115 is considered achieved when the target optical power is measured by the instrument 130.

Once the fiber 115 has been correctly positioned, the fiber 115 is attached to the OSA support substrate 110 at a first attachment point. In particular, as shown in FIG. 1B, the fiber 115 is attached, e.g. bonded by solder 135a, to the OSA support substrate surface at a first fiber bonding site 110a, for example a metallization provided on the substrate 110. The fiber 115 is preferably bonded to the substrate 110 in a region intermediate between the input termination 115a and the Bragg grating 120. For example, in order to bond the fiber to the substrate 110, as described in WO 01/91259, the fiber 115 may be externally metallized in a fiber section region including the fiber attachment region, for example in the fiber section from the input termination to the Bragg grating; in correspondence of the substrate bonding site 110a, a micro-heater may be integrated, e.g. a resistor (not shown in the drawings); after the fiber has been properly positioned in the way previously described, the micro-heater is energized so as to generate, for example by Joule effect, sufficient heat to cause reflow or reliquification of the solder alloy that bonds the fiber to the substrate. Other attachment techniques are however possible, the way the fiber is attached to be substrate not being a limitation for the present invention.

In this way, a HDBR laser emitting the desired optical power is obtained; the emission spectrum is relatively narrow, a peculiarity of this type of laser; the emission wavelength is determined by the frequency response of the Bragg grating in a stressed condition that corresponds to a substantially zero stress, i.e. such a wavelength corresponds to the reflection wavelength of the Bragg grating in a substantially zero-stress condition.

In order to tune the laser emission wavelength to the desired value, particularly according to the ITU wavelengths grid, which may, and typically does, differ from the above-mentioned substantially zero-stress emission wavelength, to the Bragg grating 120 is applied a controlled stress; in particular, as shown in FIG. 1C, to the fiber 115 is applied an axial stress STR from the side opposite the input termination 115a by properly pushing or pulling the fiber, e.g. by hand or in automated way; this causes the fiber section wherein the Bragg grating 120 is formed to be either stretched, in case the axial stress STR is a tensile, extension stress, or compressed, in case the axial stress STR is a compressive stress. While the stress STR is applied to the fiber 15, the emission wavelength of the HDBR laser is monitored, using a suitable instrument 140, such as a spectrum analyzer connected to the output termination of the fiber 115. The axial stress applied to the fiber 115 varies the position of the equivalent mirror EM of the Bragg grating with respect to the facet 105a of the optical active device 105; in particular, an extension stress causes a shift of the wavelength towards the red, while a compressive stress causes the emission wavelength to be shifted towards the blue.

For example, starting from a substantially zero-stress emission wavelength of 1540 nm, by applying a compressive stress of approximately 90 N, the emission wavelength may be varied by approximately 1.1 nm, or by 7 nm if a tensile stress of 0.4 GPa is applied.

Once the target emission wavelength is reached, the corresponding stress is “frozen” in the Bragg grating, by attaching the fiber 115 to the OSA support substrate 110 at a second attachment point. In particular, as shown in FIG. 1D, the fiber 115 is attached, e.g. bonded by solder 135b, to the OSA support substrate surface at a second fiber bonding site 110b, e.g. a metallization provided on the substrate 110. The fiber 115 is preferably bonded to the substrate 110 in a region downstream (coming from the input termination) the fiber section in which the Bragg grating 120 is formed. The bonding technique may, for example, be the same described in the foregoing, in connection with the first bonding.

Having thus frozen into the Bragg grating the stress that achieves the target emission wavelength, by attachment, particularly bonding the fiber 115 to the OSA, in the two attachment points, the stress applied to the fiber is maintained over time, and the Bragg grating is kept in the corresponding stress condition, so as to maintain the precision of the emission wavelength over time.

However, variations in the operating temperature, particularly the temperature of the Bragg grating, may cause the emission wavelength to change over time.

Temperature variations of the OSA, particularly of the Bragg grating 120, are reduced by the thermal regulation element, e.g. the peltier cell 125.

However, it has been observed that in some cases it might be preferable to improve the thermal regulation capabilities of the peltier cell 125. Thus, as shown in FIGS. 1E and 2, a cover or cap 150 of a thermally-conductive material, e.g. made of silicon or other semiconductors, or of metals, is provided, of shape and dimensions such that the cap 150 can be placed astride of the fiber 115, so as to preferably span for substantially the whole length of the fiber section containing the Bragg grating 120. The cap 150, having for example a “C”-shaped cross-section, is attached, preferably bonded to the OSA substrate 110 at two preferably elongated bonding areas 110c, 110d, for example metal strips that extend aside the fiber section containing the Bragg grating 120, between the first and second fiber bonding sites 110a and 110b. The cap 150, being of thermally-conductive material and being in thermal contact with the substrate 110, which in turn is thermally-regulated by the peltier cell 125, helps to maintain, in operation, the temperature of the Bragg grating 120 substantially constant, irrespective of temperature variations in the environment surrounding the Bragg grating.

The OSA 100 may at this point be placed in a respective package 155, as schematically shown in FIG. 1F. The package 155 may for example be in a suitable metal material (for example in KOVAR), preferably exhibiting good properties of heat dissipation, but scarcely dilatable with increase of temperature. The package 155 has a hollow bottom 160, adapted to accommodate the OSA 100 and provided with a lateral passage 165 for the optical fiber 115, and a cover 170. Reophores 175 protrude from the package, the ends thereof internal to the package being electrically connected to electric terminals of the OSA 100 (not shown for the sake of clarity).

Thanks to the provision of the cap 150, even though the Bragg grating 120 may be positioned relatively far away from the peltier cell 125, close to the package cover 170, the heat originated outside the package 155, possibly flowing thereinto, typically does not substantially affect the frequency response of the Bragg grating, whose operating temperature is kept regulated by the fact that the cap 150 is thermally-conductive, and is placed in thermal contact with the substrate 110, in turn thermally-stabilized by the thermal regulation element 125. The cap 150 acts in other words as a thermal shield for the Bragg grating 120.

It is observed that the OSA support substrate 110 might as well be mounted onto the peltier cell 125 at the time the OSA 100 is inserted into the package 155, instead of before.

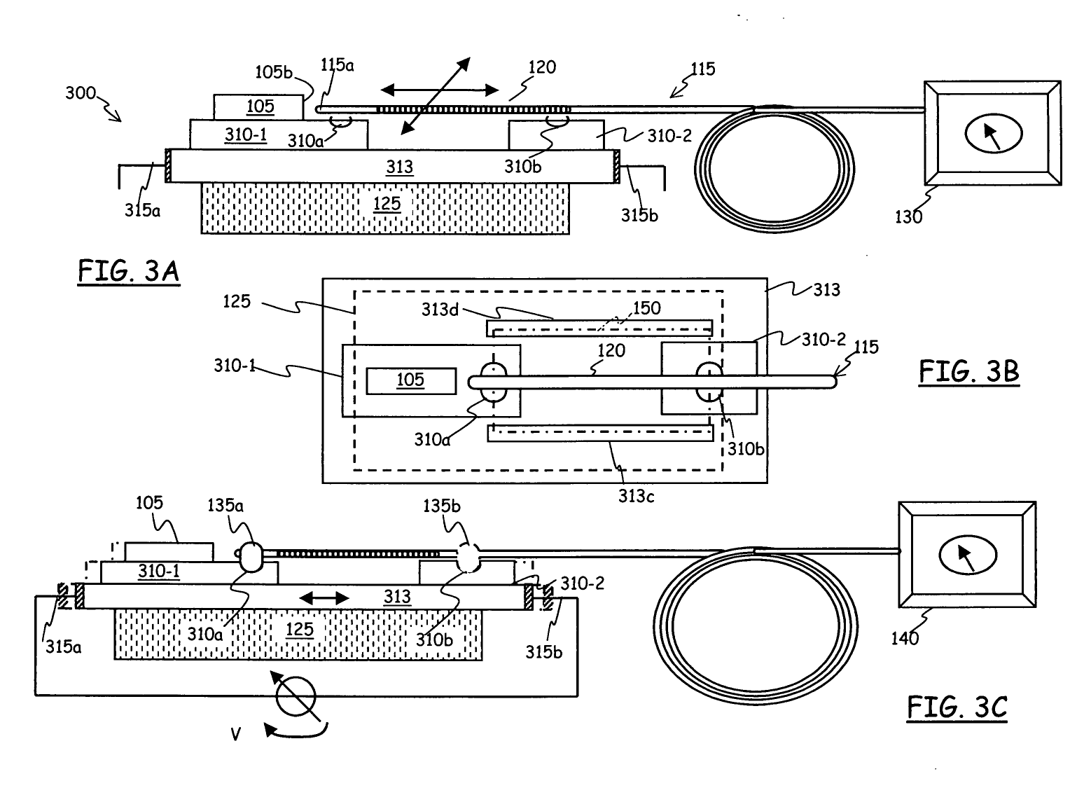

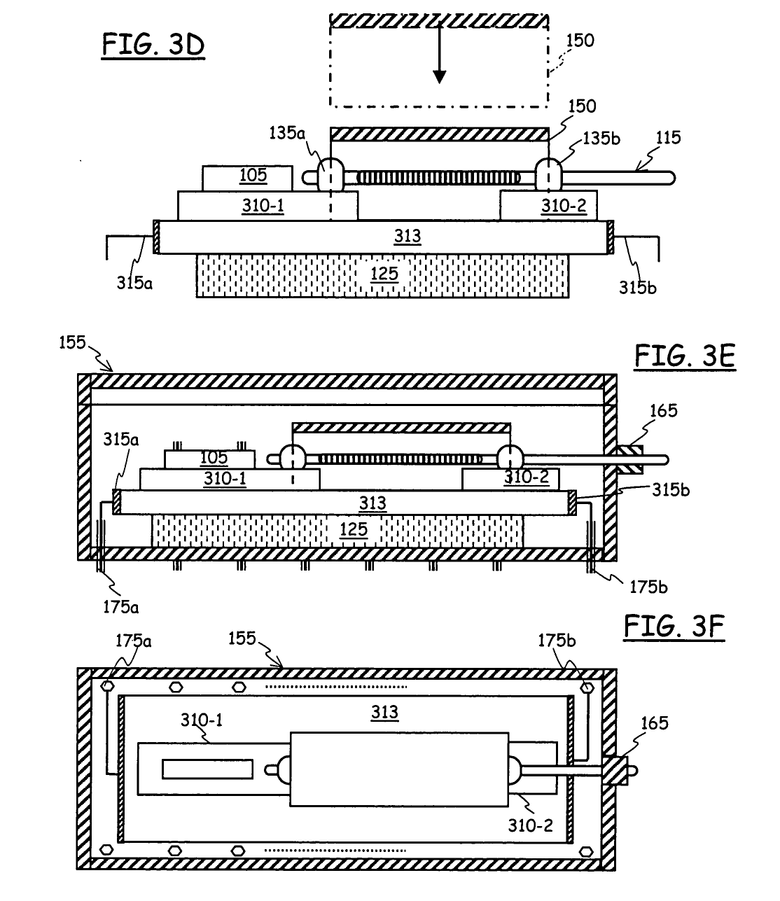

Another embodiment of the present invention is presented in FIGS. 3A to 3F. Differently from the previously described embodiment, an OSA 300 comprises first and second OSA support substrates 310-1 and 310-2, which, similarly to the OSA support substrate 110 of the previous embodiment, are made of a material having sufficiently high thermal conductivity properties, for example of silicon or other materials, as mentioned previously. The optical active element 105 is attached, e.g. bonded to the first OSA substrate 310-1; the first OSA substrate 310-1 includes, in addition to the bonding area for the chip of the optical active element 105, a first fiber bonding site 310a, intended for bonding the fiber 115. The second OSA substrate 310-2 includes a second fiber bonding site 310b for bonding the fiber 115; the first and second fiber bonding sites 310a and 310b are for example metallizations provided on the substrates 310-1 and 310-2, respectively.

The first and second OSA substrates 310-1 and 310-2 are soldered to a common substrate 313, in a thermally-conductive material. In particular, the common substrate 313 is made of a controllably deformable material, particularly a piezoelectric material, and is provided with a first and a second electrodes 315a and 315b adapted for applying a suitable electric field to the common substrate 313, so as to induce therein a controlled deformation.

The fiber 115 is first positioned having care to ensure a proper alignment, and the distance of the fiber input termination 115a with respect to the radiation-emitting, second facet 105b of the element 105, so as to ensure good optical coupling. As in the first embodiment described before, the optical power coupled into the fiber 115 may be measured by a suitable instrument 130, for example an optical power meter connected to an output termination of the fiber 115. While the fiber 115 is moved on the OSA substrate 110 with respect to the optical active element 105, the optical power emitted by the latter and coupled into the fiber is monitored by the optical power meter 130; the correct positioning of the fiber 115 is considered achieved when a target optical power is measured by the instrument 130.

Once the fiber 115 has been correctly positioned, it is attached to the first OSA substrate 310-1 at a first attachment point. In particular, as shown in FIG. 3C, the fiber 115 is attached, e.g. bonded by solder 135a, to the first OSA substrate 310-1 at the first fiber bonding site 310a, preferably in a region of the fiber intermediate between the input termination 115a and the Bragg grating 120. The bonding may for example be accomplished in the way described in the foregoing.

Two exemplary procedures are presented hereinafter that are adapted to tune the emission wavelength of the laser.

A first tuning procedure calls for attaching, e.g. bonding (by solder) 135b the fiber 115 to the second OSA substrate 310-2, at the second fiber bonding site 310b in an initial stress condition of substantially zero stress, without controlling the emission wavelength before attaching the fiber, but having care to ensure that the piezoelectric material common substrate 313 is not in either one of the two full-scale conditions (i.e., maximum extension or maximum contraction); this can for example be done by applying to the piezoelectric common substrate 313 a suitable voltage V through the electrodes 315a and 315b, where by suitable voltage there is intended a voltage such that the piezoelectric material is not in a full-scale condition (i.e., neither a zero voltage nor a maximum applicable voltage), and keeping the common substrate biased in this way while attaching the fiber 115 at the second point. Thus, the substantially zero-stress condition of the Bragg grating 120 corresponds to a deformation state of the common substrate 313 that is intermediate to the full-scale deformation conditions of the piezoelectric material. At a later stage, possibly directly in use, the emission wavelength of the laser can be tuned by properly biasing the common substrate 313, applying to the common substrate 313 a voltage higher or lower than the voltage V corresponding to the initial zero-stress condition of the Bragg grating, so as to vary the position of the Bragg grating equivalent mirror and thus tune the emission wavelength of the laser.

A second tuning procedure calls for preliminarily bringing the deformable common substrate 313 of piezoelectric material to a selected one of the two opposite full-scale deformation conditions, i.e. maximum extension or maximum contraction; this can be done by applying to the common substrate 313 a suitable voltage V, through the electrodes 315a and 315b; for example, a voltage V substantially equal to zero may correspond to a rest condition of the material, corresponding (case (a)) for example to the maximum contraction (first full-scale), while a voltage V equal to the maximum applicable voltage may correspond (case (b)) to a maximum extension condition of the material (second full-scale). Before attaching the fiber 115 at the second point, it is determined that the laser emission wavelength is slightly lower (in case (a)) or slightly higher (in case (b)) than the target wavelength, e.g. the center-band wavelength of the selected ITU channel. This can be done by monitoring the emission wavelength of the laser by means of a suitable instrument, e.g. the spectrum analyzer 140, and if necessary, applying a controlled (axial) stress to the fiber 115, thus to the Bragg grating 120. The fiber 115 is then bonded 135b to the second bonding site 310a. In this way, the emission wavelength of the laser can be tuned even at a later time, possible in use, by applying a suitable voltage to the piezoelectric common substrate 313. In particular, in case (a), by applying to the piezoelectric material a voltage V higher than zero, the common substrate 313 is caused to extend, thus a shift of the laser emission wavelength towards the red is achieved; in case (b), by applying to the piezoelectric material a voltage V lower than the maximum voltage, the extension of the common substrate 313 is reduced, thus a shift towards the blue of the emission wavelength is achieved.

Referring to FIG. 3D, as in the first embodiment described, the thermally-conductive cap 150 may be provided, positioned astride the fiber section in which the Bragg grating is formed, and it is attached, e.g., bonded to the common substrate 313, for example at two elongated bonding areas 313c, 313d, for example metal strips, that extend aside the fiber section containing the Bragg grating 120, between the first and second fiber bonding sites 310a and 310b. The cap 150, being of thermally-conductive material and being in thermal contact with the common substrate 313, which in turn is thermally-regulated by the peltier cell 125, provides that, in operation, the temperature of the Bragg grating 120 is kept substantially constant, irrespective of temperature variations in the environment surrounding the Bragg grating.

The OSA 300 may, at this point, be placed in the respective package 155, as schematically shown in FIGS. 3E and 3F. Two 175a, 175b of the reophores 175 that protrude from the package are in this case connected to the electrodes 315a and 315b of the common substrate 313, so as to enable finely tuning the laser emission wavelength directly by the user.

Compared to the first embodiment described, this second embodiment offers the possibility of tuning the emission wavelength directly by the user, while preserving the precision and stability over time properties.

The embodiments described so far have made reference to an HDBR laser, including an active optical device such as a laser diode.

The present invention is not limited to this kind of application, being instead in general applicable to optical devices including a Bragg grating whose wavelength are tuned and made stable.

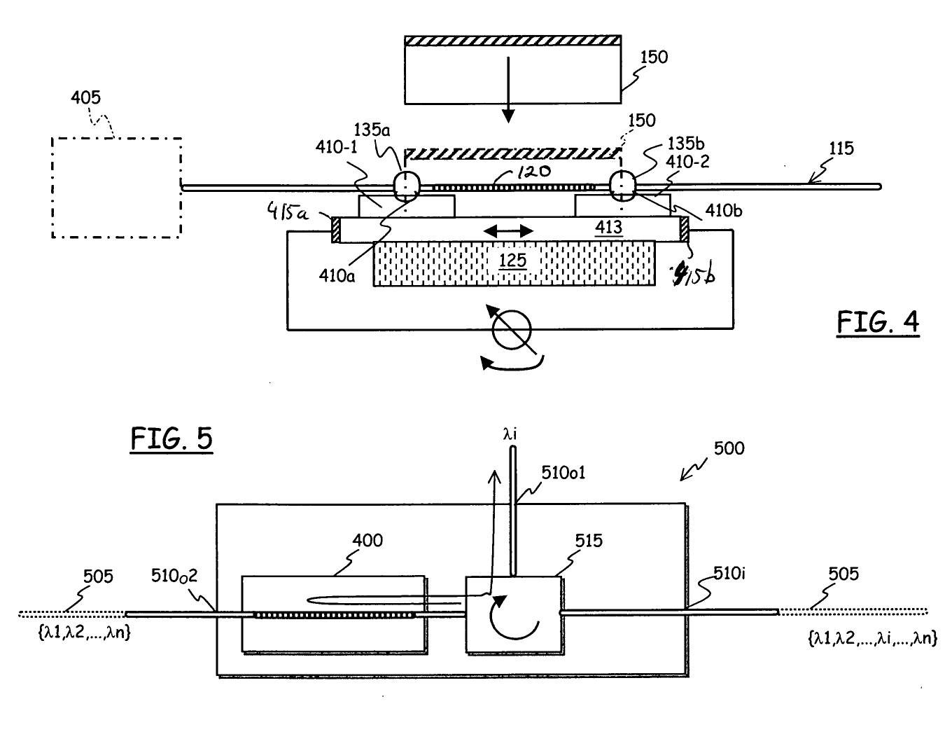

For example, in FIG. 4 there is schematically shown a different optical device 400, including an optical fiber span 115 in which a Bragg grating 120 is formed. Similarly to the second embodiment described in the foregoing, two substrates 410-1 and 410-2 are provided, attached to a common substrate 413 of controllably deformable material, e.g., a slab of piezoelectric material. The two substrates 410-1 and 410-2 each include a respective fiber bonding site 410a, 410b, for bonding the fiber 115 in two regions thereof, located before and after the Bragg grating 120. The common substrate 413 has two electrodes 415a and 415b through which a voltage can be applied to the common substrate 413 so as to induce deformation thereof.

The packaging of the optical device 400 can proceed as described in connection with the second embodiment; in order to monitor the optical device emission wavelength, an external optical source 405 may be used in place of the laser 105 of the previous embodiments.

The provision of the thermally-conductive cap 150 aids in maintaining the thermal stability of the Bragg grating.

The optical device 400 can, for example, be used in an optical receiver 500, schematically depicted in terms of functional blocks in FIG. 5, for the use, e.g., in a WDM optical communications system. The receiver 500 has an input port 510i connected to an optical communication line 505 of the optical communication system, a first output port 510o1 for connection to a local branch of the communication system, e.g. a local user equipment or a local sub-network, and a second output port 510o2 for the connection to the optical communication line 505. Through the input port 510i, a multiple wavelength optical signal, e.g. a WDM signal, is fed to an optical circulator 515. Between a first output of the optical circulator 515 and the second output port 510o2 of the receiver there is inserted the optical device 400, that acts as a wavelength-selective filter, reflecting back optical signals (centered around) a selected (center) wavelength λi. The reflected signal is returned to the optical circulator 515, and is output through the first output port 510o1, while the remaining component signals of the WDM signal, at different wavelengths, are passed through the device 400 and returned to the optical communication line 505. Thanks to the embodiment described in the foregoing in connection with FIG. 4, the device 400 can be made tunable, e.g. by acting on the piezoelectric material of the common substrate 413; it is thus possible to realize a tunable optical receiver, that can be tuned onto the desired wavelength λi.

Although the present invention has been disclosed and described by way of some embodiments, it is apparent to those skilled in the art that several modifications to the described embodiments, as well as other embodiments of the present invention are possible without departing from the spirit and scope thereof.

1. A method for producing an optical device including a Bragg grating formed in an optical waveguide, the method comprising:
providing a support substrate;
positioning the optical waveguide on the substrate with respect to an optical source so as to achieve a desired optical coupling of optical power emitted by the optical source into the optical waveguide;
attaching the waveguide to the support substrate in correspondence of a first location along the waveguide, said first location being at one side of the Bragg grating;
attaching the waveguide to the support substrate in a correspondence of a second location along the waveguide, said second location being at an opposite side of the Bragg grating, so as to fix the Bragg grating in a first stressed condition.

2. The method according to claim 1, in which said attaching comprises:
providing a first and a second solder-wettable areas on said support substrate;
providing solder-wettable areas at said first and second locations along the waveguide;
bonding by soldering the solder-wettable area at the first location along the waveguide to the first solder-wettable area on the support substrate, and the solder-wettable area at the second location along the waveguide to the second solder-wettable area on the support substrate.

3. The method according to claim 1, further comprising:
applying a stress to the Bragg grating so as to vary a frequency response thereof.

4. The method according to claim 3, in which said applying a stress to the Bragg grating includes applying a mechanical stress to the waveguide.

5. The method according to claim 4, in which said applying a stress is performed before attaching the waveguide to the support substrate in a correspondence of the second location along the waveguide, and the Bragg grating is fixed in the first stressed condition when a target frequency response is attained.

6. The method according to claim 3, in which said applying a mechanical stress to the waveguide includes deforming the support substrate.

7. The method according to claim 6, in which said applying a mechanical stress to the waveguide is performed after attaching the waveguide to the support substrate in a correspondence of the second location along the waveguide, so as to vary the frequency response of the Bragg grating with respect to the frequency response corresponding to the first stress condition, and keeping the Bragg grating in a second stressed condition when a target frequency response is attained.

8. The method according to claim 7, in which the first stressed condition is such that the Bragg grating frequency response is slightly different from the target frequency response, and with the support substrate in either one of two full-scale deformation conditions.

9. The method according to claim 1, further comprising:
providing the support substrate with thermal conduction properties; and
thermally-stabilizing the support substrate.

10. The method according to claim 9, further comprising:
thermally shielding the Bragg grating.

11. The method according to claim 10, in which said thermally shielding comprises:
providing an enclosure around the Bragg grating, said enclosure being thermally conductive and being in thermal conduction relationship with the thermally-stabilized support substrate.

12. An optical device comprising:
an optical waveguide,
a Bragg grating formed in the waveguide;
a support substrate,
wherein a first and a second waveguide attachment locations, at which the waveguide is attached to the support substrate, said first and second attachment locations being located at opposite side with respect to the Bragg grating, so as to fix the Bragg grating in a first stressed condition.

13. The optical device according to claim 12, in which said support substrate is controllably deformable, a deformation of the substrate causing a stress applied to the Bragg grating that induces a change in a frequency response thereof.

14. The optical device according to claim 13, in which said support substrate comprises:
a first substrate including said first waveguide attachment location;
a second substrate including said second waveguide attachment location, and
a common substrate to which the first and second substrates are attached, the common substrate being of a controllably deformable material.

15. The optical device according to claim 14, in the common substrate is in a piezoelectric material.

16. The optical device according to claim 12, in which the support substrate is thermally conductive, and is associated with a thermal stabilizer adapted to substantially stabilize a temperature of the substrate.

17. The optical device according to claim 16, further comprising a thermal shield for the Bragg grating.

18. The optical device according to claim 17, in which said thermal shield comprises thermally conductive enclosure surrounding the Bragg grating, said enclosure being in thermal conduction relationship with the thermally-stabilized support substrate.

19. The optical device according to claim 12, further comprising an optical source optically coupled to the waveguide.

20. The optical device according to claim 19, in which said optical source includes a laser diode.

21. A method of tuning an optical device including a Bragg grating formed in an optical waveguide, the method comprising:
providing a support substrate;
positioning the optical waveguide on the substrate with respect to an optical source so as to achieve a desired optical coupling of optical power emitted by the optical source into the optical waveguide;
attaching the waveguide to the support substrate in correspondence of a first location along the waveguide, said first location being at one side of the Bragg grating;
attaching the waveguide to the support substrate in a correspondence of a second location along the waveguide, said second location being at an opposite side of the Bragg grating;
wherein a stress is applied to the Bragg grating so as to vary a frequency response thereof.

22. The method according to claim 21, in which said stress is applied to the Bragg grating before said attaching the waveguide to the support substrate in a correspondence of a second location along the waveguide.

23. The method according to claim 21, in which said stress is applied to the Bragg grating after said attaching the waveguide to the support substrate in a correspondence of a second location along the waveguide.

24. A tunable optical device including:
an optical waveguide,
a Bragg grating formed in the waveguide;
a support substrate,
wherein:
a first and a second waveguide attachment locations are provided, at which the waveguide is attached to the support substrate, said first and second attachment locations being located at opposite side with respect to the Bragg grating;
and wherein
the support substrate includes a controllably deformable material substrate, adapted to be controllably deformed so as to controllably vary a stress condition of the Bragg grating, whereby a frequency response of the optical device can be tuned.

25. A method, comprising:
securing to a platform a first location of an optical waveguide that includes a wavelength selector;
tuning the wavelength selector by applying a force to the optical waveguide; and
securing to the, platform a second location of the optical waveguide while applying the force.

26. The method of claim 25, further comprising aligning an end of the optical waveguide to an optical-signal source before securing the first location of the optical waveguide to the platform.

27. The method of claim 25 wherein securing to the first location comprises securing the first location of the optical waveguide to the platform while applying the force.

28. The method of claim 25 wherein the wavelength selector comprises a Bragg grating.

29. The method of claim 25 wherein:
the first location of the optical waveguide is to one side of the wavelength selector; and
the second location of the optical waveguide is to the second side of the wavelength selector.

30. The method of claim 25 wherein tuning the wavelength selector comprises causing the wavelength selector to reinforce a predetermined wavelength of an optical signal for propagation within the optical waveguide.

31. A method, comprising:
deforming a platform; and
attaching to the deformed platform first and second locations of an optical waveguide that includes a wavelength selector disposed between the first and second locations.

32. The method of claim 31 wherein deforming the platform comprises lengthening the platform in a dimension substantially parallel to the optical waveguide.

33. The method of claim 31 wherein deforming the platform comprises compressing the platform in a dimension substantially parallel to the optical waveguide.

34. The method of claim 31 wherein:
the platform comprises a piezoelectric material; and
deforming the platform comprises applying an electric field across a portion of the material.

35. A structure, comprising:
a platform; and
an optical waveguide secured to the platform, having an axis, and having a region that includes a wavelength selector, the region experiencing a nonzero stress along the axis.

36. The structure of claim 35 wherein the optical waveguide is secured to the platform at a first location adjacent to a first end of the region and at a second location adjacent to a second end of the region.

37. The structure of claim 35 wherein the platform stresses the region along the axis.

38. A structure, comprising:
an optical waveguide having an axis and having a region that includes a wavelength selector; and
a platform that is secured to the optical waveguide and that is operable to tune the wavelength selector by stressing the region of the optical waveguide along the axis in response to a signal.

39. An optical communication system, comprising:
a structure including,
a platform, and
an optical waveguide secured to the platform, having an axis, and having a region that includes a wavelength selector, the region experiencing a nonzero stress along the axis.

40. An optical communication system, comprising:
a structure including,
an optical waveguide having an axis and having a region that includes a wavelength selector, and
a platform that is secured to the optical waveguide and that is operable to tune the wavelength selector by stressing the region of the optical waveguide along the axis in response to a signal.
